(19) United States
(12) Patent Application Publication
(10) Pub. No.: US 2011/0205170 A1
(43) Pub. Date: Aug. 25, 2011

(54) ELECTRONIC TOUCH - SCREEN DISPLAY APPARATUS AND OPERATING METHOD THEREOF

(75) Inventor: Yung-Fang Chang, Hsinchu Hsien (TW)

(73) Assignee: MStar Semiconductor, Inc., Hsinchu Hsien (TW)

(21) Appl. No.: 12/986,680

(22) Filed: Jan. 7, 2011

(30) Foreign Application Priority Data
Feb. 24, 2010 (TW) 099105301

(51) Int. Cl. G06F 3/041

(52) U.S. Cl. 345/173

(57) ABSTRACT

A control unit of an electronic touch display apparatus, comprising: a touch signal receiving module for receiving a touch signal; a recognition module, coupled to the touch signal receiving module, for recognizing an indicated page number from the control signal; and a data processing module, coupled to the recognition module, for accessing data corresponding to the page number from a database; wherein the data are displayed on a screen of the electronic touch display apparatus, and the indicated page number may be non-adjacent to a page number corresponding to the current displayed page.

### CROSS REFERENCE TO RELATED PATENT APPLICATION

This patent application is based on a Taiwan, R.O.C. patent application No. 099105301 filed on Feb. 24, 2010.

### FIELD OF THE INVENTION

The present invention relates to an electronic display apparatus and the operation method thereof, and more particularly, to an electronic touch display apparatus and the operation method thereof.

### BACKGROUND OF THE INVENTION

In recent years, touch display devices have become important input interfaces, and are widely used in various consumer electronic products, such as personal digital assistants (PDAs), mobiles, personal computers, and notebooks. E-books, for example, are usually read on dedicated hardware devices comprising the touch display devices. However, despite the merit of easy-carrying and eco-awareness, some problems still exist in operations of current touch display devices while being utilized to read e-books.

FIG. 1 is a schematic diagram of an electronic touch display apparatus 10 of the prior art. The electronic touch display apparatus 10 may be an e-book device, a tablet computer or a touch phone, etc., comprising: a touch screen 120, a previous page button 140, a menu button 160 and a next page button 180.

When a user turns the current page to the next page, the next page button 180 is pressed; subsequently, the touch screen 120 transmits the touch signal to a control unit (not shown in the figure) of the electronic touch display apparatus 10. The control unit receives the touch signal, connects to a database storing page data, accesses the database to retrieve the page data of the next page, and switches the displayed page from the current page to the next page.

Due to the different operations of the electronic touch display apparatuses from that of traditional books, inconveniences occur while users utilize the electronic touch display apparatuses to read e-books, such as turning pages. Currently, turning pages is executed by pressing “previous page” or “next page” buttons or function keys displayed on the screens, however, it can only be executed page by page, which is much different from reading traditional books that the readers may manually advance to a particular page directly.

Therefore, there is a need for an electronic touch display apparatus having a quick and accurate page turning feature and the method thereof.

### SUMMARY OF THE INVENTION

It is therefore a primary objective of the present disclosure to provide an electronic touch display apparatus and the page turning method thereof.

The present disclosure provides a control unit of an electronic touch display apparatus, comprising: a touch signal receiving module for receiving a touch signal; a recognition module, coupled to the touch signal receiving module, for recognizing an indicated page number from the control signal; and a data processing module, coupled to the recognition module, for accessing data corresponding to the page number from a database; wherein the data are displayed on a screen of the electronic touch display apparatus, and the indicated page number may be non-adjacent (or non-sequential) to a page number corresponding to the current displayed page.

The present disclosure further provides a page turning method for a touch display apparatus, comprising: receiving a touch signal; recognizing an indicated page number from the touch signal; accessing data corresponding to the page number from a database; and displaying the data; wherein the indicated page number may be non-adjacent to a page number corresponding to the current displayed page.

The present disclosure further provides an electronic touch display apparatus, comprising: a touch device, for detecting a touch thereupon to generate a touch signal; a memory, storing a database; a control unit, coupled to the touch device and the memory, for receiving the touch signal, recognizing an indicated page number from the touch signal, accessing data corresponding to the page number from a database, and displaying the data on a screen; and a power supply unit, coupled to the touch display apparatus, the memory, and the control unit, for providing power; wherein the indicated page number may be non-adjacent to a page number corresponding to the current displayed page.

The present disclosure provides a page turning method applicable to electronic touch display apparatuses. For example, since neither an e-book device nor a touch phone has physical input equipment (e.g., a physical keyboard), with the present disclosure, users may directly turn to the target page by writing the page number on the screen, so as to facilitate the utilization of the electronic touch display apparatus to be as convenient as that of the traditional book.

### BRIEF DESCRIPTION OF THE DRAWINGS

The present invention will become more readily apparent to those ordinarily skilled in the art after reviewing the following detailed description and accompanying drawings, in which:

FIG. 1 is a schematic diagram of an electronic touch display apparatus of the prior art.

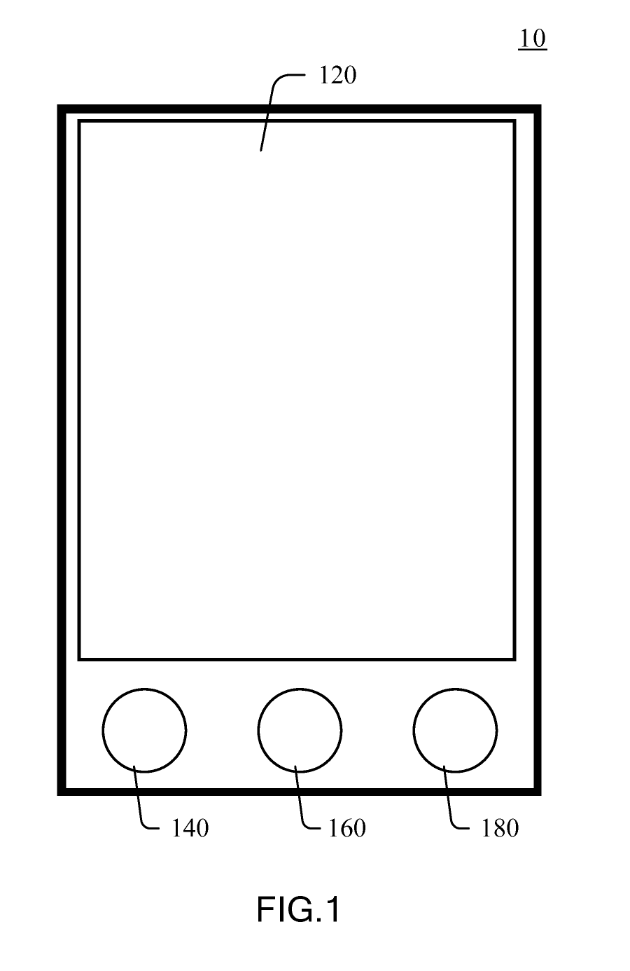

FIG. 2 is a block diagram of an electronic touch display apparatus according to an embodiment of the present disclosure.

FIG. 3 is a block diagram of the control unit in FIG. 2.

FIG. 4 is a flowchart of the corresponding page turning method of the electronic touch display apparatus in FIG. 2.

FIG. 5 is a schematic diagram of operations of an electronic touch display apparatus according to an embodiment of the present disclosure.

### DETAILED DESCRIPTION OF THE PREFERRED EMBODIMENT

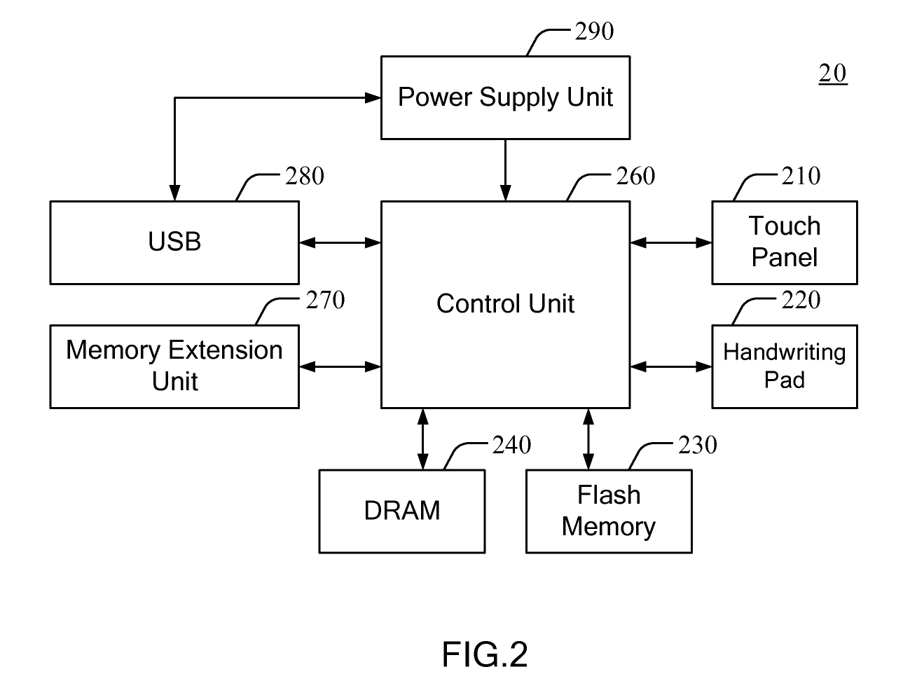

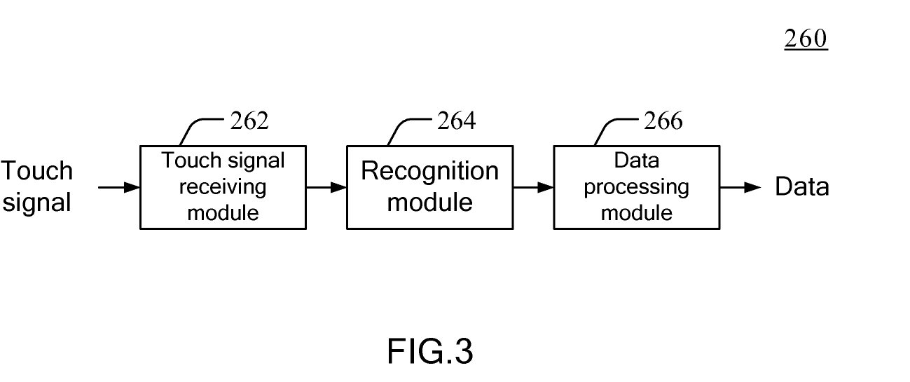

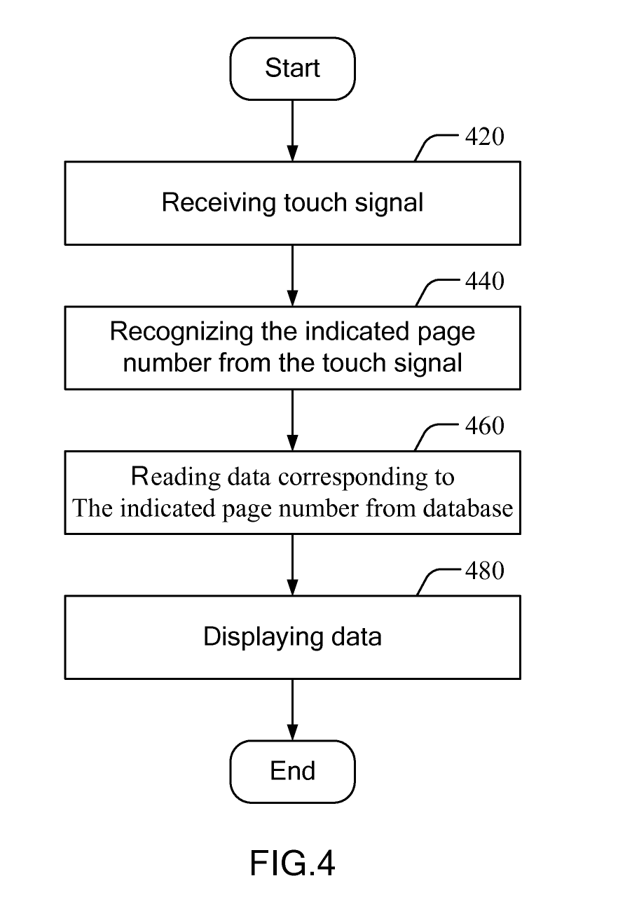

Please refer to FIG. 2, FIG. 3, and FIG. 4 together. FIG. 2 is a block diagram of a electronic touch display apparatus 20 according to an embodiment of the present disclosure, comprising: a touch panel 210, a handwriting pad 220, a flash memory 230, a dynamic random access memory (DRAM) 240, a control unit 260, a memory expansion unit 270, an universal serial bus (USB) 280 and a power supply unit 290. The flash memory 230 stores a database, storing the page data of the e-book. FIG. 3 is a block diagram of the control unit 260, comprising a touch signal receiving module 262, a recognition module 264 and a data processing module 266. FIG. 4 is a flowchart of the corresponding page turning method of the electronic touch display apparatus.

A touch signal is generated when the touch panel 210 or the handwriting pad 220 senses a touch. The touch signal receiving module 262 of the control unit 260 receives the touch signal in step 420 in FIG. 4. Then, the recognition module 264 recognizes the indicated page number from the touch signal in step 440. The data processing module 266 accesses data corresponding to the indicated page number from the database, which can be stored in the flash memory 230 or the DRAM 240, and when more memory is required, the data may also be stored in the memory expansion unit 270 or external memory devices connected via the USB (not shown in the figure). And in step 480, the data corresponding to the indicated page number are displayed on the screen (not shown in the figure) of the electronic touch display apparatus 20.

The power supply unit 290 may directly supply power to the touch panel 210, the handwriting pad 220, the flash memory 230, the dynamic random access memory 240 and the control unit 260, or the apparatus may also be charged by external charging devices via the USB 280. For example, the electronic touch display apparatus may be an e-book device, a tablet computer, a touch phone or an electronic device comprising a handwriting pad.

As can be seen from the above, the present disclosure utilizes the already existed touch panel or the handwriting pad to generate the touch signal for delivering the indicated page number, and the data processing module access the data from the already existed database. That is to say, by adding the touch signal receiving module, the recognition module and the data processing module to a touch display device, the present disclosure is capable of performing direct and accurate page turning processes. As a result, great utilization convenience can be achieved.

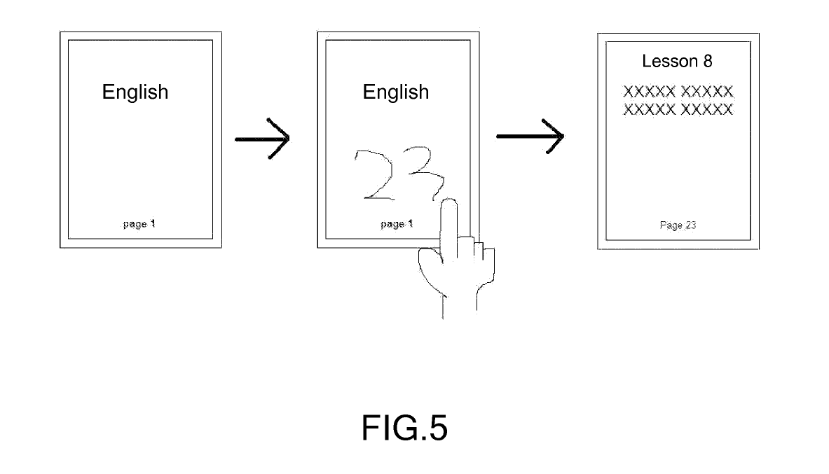

Referring now to FIG. 5, a schematic diagram of operations of an electronic touch display apparatus according to an embodiment of the present disclosure is shown. In this embodiment, the present disclosure may be applied to an e-book device as depicted in FIG. 5. Through the touch screen, a user may directly write down or input the page number (for example, page 23) onto the screen, causing the electronic touch display apparatus to automatically advance to page 23, which is as convenient as manipulating physical pages of a book.

In another embodiment, the page turning signal may be inputted by scribbling down page numbers or characters and inputting a page-turning activating signal on various e-book devices, mobile phones or tablet computers having built-in touch screens. After the touch signal receiving module receives the page turning signal, the recognition module starts recognizing the indicated page number, and the electronic display apparatus then may display the page represented by the numbers or the characters, and the page can be a non-adjacent page of the previous page. That is, the page-turning function described in the present disclosure needs not to go through a page by page turning process for reaching the target page. Wherein, the page turning signal may be inputted by scribbling on a particular region of the display panel or by pressing a physical button.

Note that the touch display apparatus is a general term of an electronic device capable of performing touch-sensing and display functions. The details vary according to the application scope and system realizations, and the deviated variations or modifications are all within the scope of the present invention.

In another embodiment, the present disclosure may also be applied to more powerful computers. For example, with the trend of integrating touch panels with computers, the present disclosure may be utilized in such devices. Additionally, the present invention can also be applied to other products having built-in touch control modules, touch screens or touch display apparatus, such as personal digital assistants (PDAs), mobile devices, smart telephones, etc.

Furthermore, the present disclosure may also be realized using software applications. The touch screen receives input numbers or characters, and the touch signal receiving module sends the touch signal to the control unit of the electronic touch display apparatus for recognition, and the present disclosure may be realized by computing with the database storing the page data.

In summary, the present disclosure provides a page turning method applicable to electronic touch display apparatuses. For example, since neither an e-book device nor a touch phone has physical input peripheral equipment, (e.g., a physical keyboard), with the present disclosure, users may directly turn to the target page by writing the page number on the screen, so as to facilitate the utilization of the electronic touch display apparatus to be as convenient as that of the traditional book.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A control unit, for use in an electronic touch display apparatus, comprising:
a touch signal receiving module, for receiving a touch signal;
a recognition module, coupled to the touch signal receiving module, for recognizing an indicated page number from the touch signal; and
a data processing module, coupled to the recognition module, for accessing data corresponding to the indicated page number;
wherein the data are displayed on a screen of the electronic touch-screen display apparatus.

2. The control unit according to claim 1, wherein the indicated page number is non-adjacent to a page number corresponding to a currently displayed page.

3. The control unit according to claim 1, wherein the recognition module starts recognizing the indicated page number of the touch signal after the touch signal receiving module receives a page turning signal.

4. The control unit according to claim 1, wherein the electronic touch display apparatus is an e-book device.

5. The control unit according to claim 1, wherein the electronic touch display apparatus is a tablet computer.

6. The control unit according to claim 1, wherein the electronic touch display apparatus is a touch phone.

7. The control unit according to claim 1, wherein the electronic touch display apparatus comprises a handwriting pad, which senses a touch to generate the touch signal.

8. A page turning method for use in a touch display apparatus, comprising:
receiving a touch signal;
recognizing an indicated page number associated with the touch signal;
accessing data corresponding to the page number; and
displaying the data.

9. The page turning method for an electronic touch display apparatus according to claim 8, wherein the indicated page number is non-adjacent to a page number corresponding to the current displayed page.

10. The page turning method for an electronic touch display apparatus according to claim 8, further comprising:
receiving a page turning signal; and
starting to recognize the indicated page number from the touch signal after the touch signal receiving module receives the page turning signal.

11. An electronic touch display apparatus, comprising:
a touch device, for detecting a touch thereupon to generate a touch signal;
a memory, storing a database; and
a control unit, coupled to the touch device and the memory, for receiving the touch signal, recognizing an indicated page number associated with the touch signal, accessing data corresponding to the indicated page number from the database, and displaying the data on a screen.

12. The electronic touch display apparatus according to claim 11, wherein the indicated page number is non-adjacent to a page number corresponding to the current displayed page.

13. The electronic touch display apparatus according to claim 11, wherein the control unit starts recognizing the indicated page number of the touch signal after receiving a page turning signal.

14. The electronic touch display apparatus according to claim 11, wherein the electronic touch display apparatus is an e-book device.

15. The electronic touch display apparatus according to claim 11, wherein the electronic touch display apparatus is a tablet computer.

16. The electronic touch display apparatus according to claim 11, wherein the electronic touch display apparatus is a touch phone.

17. The electronic touch display apparatus according to claim 11, wherein the electronic touch display apparatus comprises a handwritingpad.
